(19) United States
(12) Patent Application Publication
(10) Pub. No.: US 2026/0251786 A1
(43) Pub. Date: Aug. 27, 2026

(54) ACOUSTICS-BASED WETLAND SURFACE ELEVATION MEASURING INSTRUMENT AND MEASUREMENT METHOD

(71) Applicant: Xiamen University, Xiamen City (CN)

(72) Inventors: Luzhen CHEN, Xiamen City (CN); Yue MENG, Xiamen City (CN); Jialin JHANG, Xiamen City (CN); Yu ZHANG, Xiamen City (CN); Xiaoxuan GU, Xiamen City (CN); Fei ZHANG, Xiamen City (CN)

(21) Appl. No.: 19/423,211

(22) Filed: Dec. 17, 2025

(30) Foreign Application Priority Data
Feb. 26, 2025 (CN) 202510215317.5

(51) Int. Cl. G01S 15/08; G01D 21/02; G01S 7/521; G01S 15/00

(52) U.S. Cl. CPC G01S 15/08; G01D 21/02; G01S 7/521; G01S 15/006

(57) ABSTRACT

An acoustics-based wetland surface elevation measuring instrument and measurement method are disclosed. The measuring instrument includes a measurement cross arm, an auxiliary device base station, and a base; the measurement cross arm includes a cross-arm body and an acoustic depth sounder, and the acoustic depth sounder measures a distance to a wetland surface by detecting reflections of sound waves in water; a wetland surface elevation change rate is obtained by calculating differences in these distances measured at different time points, and a communication and control module enables remote, scheduled data acquisition and transmission. The present invention significantly reduces errors and costs associated with manual measurements, facilitates monitoring at finer temporal scales, and ensures long-term, stable operation in harsh environments such as coastal wetlands.

### CROSS-REFERENCE TO RELATED APPLICATIONS

This application claims priority to Chinese Patent Application 202510215317.5, filed on Feb. 26, 2025, which is incorporated herein by reference.

### TECHNICAL FIELD

The present invention relates to the field of methods for measuring wetland surface elevation changes, and particularly to an acoustics-based wetland surface elevation measuring instrument and measurement method.

### BACKGROUND

Wetland surface elevation change is one of the important indicators in ecosystem risk assessment. Especially in intertidal zones of coastal wetlands, minor changes in surface elevation (on the millimeter scale) play a key role in assessing the sensitivity of coastal intertidal zones to future climate change, particularly sea level rise. Among current in-situ methods for measuring wetland surface elevation changes, a surface elevation table-marker horizon method (SET-MH or SET for short) is a widely recognized method both domestically and internationally (refer to patents with application Nos. 201510046080.9 and 201520780019.2). However, in practical measurement processes, this method requires significant human and material resources, and relies on the visual measurements of personnel, which inevitably introduces human-induced errors into the elevation measurement accuracy. Furthermore, measurement frequency is limited by the availability of manpower and material resources, making frequent monitoring difficult and thus hindering its application in studies with finer temporal scales. At present, although improved automated surface elevation measuring instruments exist, such measuring instruments feature complex mechanical structures and their durability has not been adequately taken into account under the harsh, tidal environment of coastal wetlands. Additionally, these instruments have high manufacturing, installation, and subsequent maintenance costs, resulting in limited practicality and making widespread application difficult.

### SUMMARY

To solve the above-mentioned problems in the prior art, the present invention provides an acoustics-based wetland surface elevation measuring instrument and measurement method, and the measuring instrument features automation, high accuracy, simple structure, and long-term stable operation.

To achieve the above objective, the following technical solutions are adopted in the present invention:

The present invention provides an acoustics-based wetland surface elevation measuring instrument, and the measuring instrument includes: a base, a measurement cross arm, and an auxiliary device base station, where a first end of the base is connected to the measurement cross arm, and a second end of the base is vertically anchored to a wetland geological layer. The measurement cross arm includes a cross-arm body and an acoustic depth sounder, where the acoustic depth sounder is disposed on the cross-arm body. The auxiliary device base station includes a fixed tube, and a temperature-salinity-depth meter, a communication and control module and a power supply device that are disposed on the fixed tube. The fixed tube is vertically fixed to the wetland geological layer. The temperature-salinity-depth meter includes a probe for recording water level, temperature, and salinity, and the probe of the temperature-salinity-depth meter is maintained at a same horizontal level as a lower end of the acoustic depth sounder. The communication and control module is used for data acquisition and transmission; and the power supply device is used for supplying power to the acoustics-based wetland surface elevation measuring instrument.

Further, the number of the cross-arm bodies is determined according to measurement requirements, and the cross-arm bodies are arranged in a circumferential array, with equal horizontal angles between the cross-arm bodies.

Further, the number of acoustic depth sounders is determined by measurement requirements, no less than three acoustic depth sounders are disposed on each cross-arm body, and the acoustic depth sounders are fixed onto the cross-arm body at equal intervals.

Further, the number of the acoustic depth sounders on each cross-arm body is 3 to 9.

Further, the power supply device includes a solar panel for power generation and a battery for energy storage.

Further, the communication and control module is connected to the temperature-salinity-depth meter and the acoustic depth sounder respectively via corrosion-resistant wires.

The present invention further provides a wetland surface elevation measurement method based on the acoustics-based wetland surface elevation measuring instrument, and the method includes the following steps: S1: installing a base in a measurement area and leveling a cross-arm body to complete installation and positioning; S2: acquiring a real-time water temperature (T) and salinity(S) using the temperature-salinity-depth meter to obtain environmental parameter; and then calculating the in-situ speed of sound (V) in water according to the Del Grosso equation for the speed of sound in natural waters; S3: operating an acoustic depth sounder and the temperature-salinity-depth meter simultaneously to measure the time (t) for an acoustic wave to travel toa wetland surface and is reflected back toa bottom of the acoustic depth sounder; and calculating the height (h) from the bottom of the acoustic depth sounder to the wetland surface using the formula

$$h = \frac{V \times t}{2} ,$$

thereby completing the elevation measurement; and S4: measuring height data at time t₁ and t₂ using n acoustic depth sounders, and obtaining datasets {H₁, H₂ . . . , Hₙ} and {h₁,h₂ . . . , hₙ} respectively; calculating the average difference (d) with the formula

$$d = {\sum }_{i} \frac{{H}_{i} - {h}_{i}}{n} ,$$

and calculating the surface elevation change using a surface elevation change rate

$$η = \frac{d}{{t}_{2} - {t}_{1}} .$$

Further, the Del Grosso equation for the speed of sound in natural waters is V=1449.2+4.67−0.055T²+0.00029T³+(1.34−0.01T)(S−35)+0.016D, where T is water temperature, S is salinity, and D is depth.

Compared with the prior art, the technical solutions of the present invention offer the following advantages:

The present invention enables remote, scheduled data acquisition and transmission through the integrated use of the acoustic depth sounder and the communication and control module in the auxiliary device base station. Compared with current manual data collection methods, the measurement method of the present invention significantly reduces the errors and costs associated with manual measurements, offering superior accuracy and efficiency, which facilitates monitoring of wetland surface elevation changes at finer temporal scales and broadens the scope of application research. Furthermore, the measuring instrument of the present invention features a simple structure and enables long-term and stable operation even in harsh environments such as coastal wetlands.

### BRIEF DESCRIPTION OF DRAWINGS

FIG. 1 is a schematic diagram of an overall structure of a wetland surface elevation measuring instrument in this embodiment;

FIG. 2 is a schematic diagram of application of a wetland surface elevation measurement method in this embodiment; and

FIG. 3 is a schematic diagram of another overall structure of a wetland surface elevation measuring instrument with dual measurement cross arms in this embodiment.

Reference numerals: 1: base; 2: measurement cross arm; 3: auxiliary device base station; 11: reference tube; 12: stabilizing tube; 13: base connector; 21: cross-arm connection end; 22: leveling device; 23: gradienter; 24: acoustic depth sounder; 25: cross-arm body; 31: fixed tube; 32: temperature-salinity-depth meter; 33: communication and control module; and 34: power supply device.

### DESCRIPTION OF EMBODIMENTS

In order to make the technical problem to be solved, technical solutions, and beneficial effects of the present invention clear and comprehensible, the present invention is described in further detail below with reference to the accompanying drawings and embodiments.

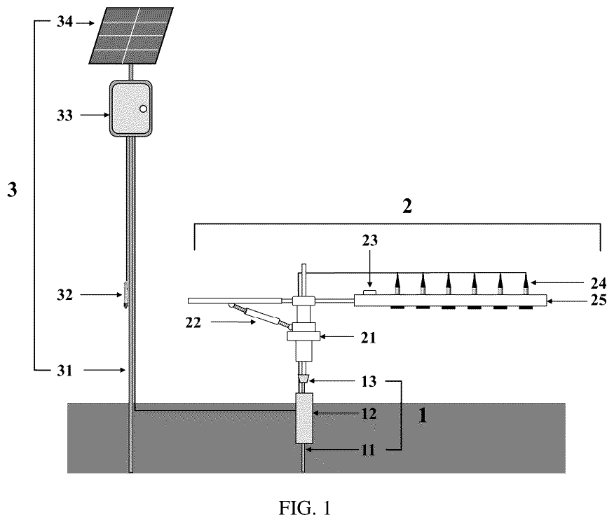

Referring to FIG. 1 to FIG. 3, this embodiment provides an acoustics-based wetland surface elevation measuring instrument (hereinafter referred to as a wetland surface elevation measuring instrument), and the measuring instrument includes a base 1, a measurement cross arm 2, and an auxiliary device base station 3.

A first end of the base 1 is connected to the measurement cross arm 2, and a second end of the base 1 is vertically anchored to a wetland geological layer. Specifically, the base 1 includes a reference tube 11 vertically anchored to a stable geological layer, a stabilizing tube 12 arranged around the reference tube 11, and a base connector 13 disposed at a top of the reference tube 11. In this embodiment, the base 1 is anchored via the reference tube 11 to an underground stable layer, which ensures the overall elevation of the base 1 remains constant and provides a stable reference for measurement. The stabilizing tube 12, typically constructed from concrete and PVC pipes, is positioned around the reference tube 11 to provide stability within the wetland and to mitigate the impact of hydrodynamic forces such as waves.

The measurement cross arm 2 includes a cross-arm body 25 and an acoustic depth sounder 24 installed on the cross-arm body 25. The cross-arm body 25 is equipped with a cross-arm connection end 21, a leveling device 22, and a gradienter 23. The measurement cross arm 2 is screwed to the base connector 13 via its connection end 21. The leveling device 22 and the gradienter 23 work in conjunction to ensure the cross-arm body 25 is in a horizontal state after installation. The acoustic depth sounder 24 determines a distance to the wetland surface by measuring the time-of-flight of acoustic wave reflections in water. The surface elevation change rate is obtained by calculating the difference in distances measured at different times.

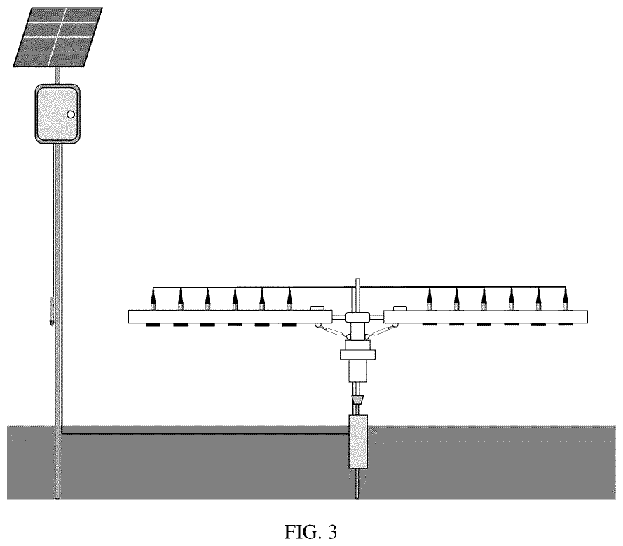

The number of the cross-arm bodies 25 is determined by measurement requirements. The cross-arm bodies 25 are arranged in a circumferential array with equal horizontal angles between the cross-arm bodies 25. For example, one measurement cross arm 2 may be installed, or two measurement cross arms 2 may be installed, in which case the horizontal included angle is 180 degrees. In other embodiments, four measurement cross arms 2 may be installed, and the horizontal included angle between the measurement cross arms is 90 degrees. The number is not limited to one or two measurement cross arms 2 as shown in FIG. 1 and FIG. 3.

The number of the acoustic depth sounders 24 is determined by measurement requirements. No less than three acoustic depth sounders 24 are mounted on each cross-arm body 25 at equal intervals. Generally, the number of the acoustic depth sounders 24 on each cross-arm body 25 is 3 to 9, and in this embodiment, the number of the acoustic depth sounders on each cross-arm body is 6.

The auxiliary device base station 3 includes a fixed tube 31, and a temperature-salinity-depth meter 32, a communication and control module 33 and a power supply device 34 that are disposed on the fixed tube 31. The fixed tube 31 is vertically fixed to the wetland geological layer. The temperature-salinity-depth meter 32 includes a probe for recording water level, temperature, and salinity, with the probe maintained at the same horizontal level as a lower end of the acoustic depth sounder 24. The communication and control module 33 is used for data acquisition and transmission, specifically can receive remote commands and send relevant measurement data. The communication and control module 33 is connected to the temperature-salinity-depth meter 32 and the acoustic depth sounder 24 respectively via corrosion-resistant wires. The power supply device 34 is used for supplying power to the entire acoustics-based wetland surface elevation measuring instrument and includes a solar panel for power generation and a battery for energy storage. The fixed tube 31 is made of 304 stainless steel.

Additionally, this embodiment employs a measurement method based on the aforementioned instrument, which includes the following steps:
Step S1: installation and positioning: installing the wetland surface elevation measuring instrument of the present invention in a measurement area, and after installation, ensuring that a cross-arm body 25 is in a horizontal state.
Step S2: environmental parameter acquisition: using a temperature-salinity-depth meter 32 to confirm that the water level in the measurement area is above the lower end of the acoustic depth sounder 24, then issuing a measurement command; acquiring real-time water temperature (T) and salinity(S) via the temperature-salinity-depth meter 32, and calculating the in-situ speed of sound (V) in water according to the Del Grosso equation for the speed of sound in natural waters:

$$V = 1449.2 + 4.6 T - 0.055 {T}^{2} + 0.00029 {T}^{3} + ( 1.34 - 0.01 T ) ( S - 35 ) + 0.016 D$$

where V is the speed of sound (m/s), T is the water temperature (° C.), S is the salinity (%), and D is the depth (m). Given the shallow-water application scenario to this embodiment, the depth term (D) is omitted from the speed of sound calculation.
Step S3: elevation measurement: operating the acoustic depth sounder 24 and the temperature-salinity-depth meter 32 simultaneously to measure the time (t) taken for an acoustic wave to travel to a wetland surface and return to the bottom of the acoustic depth sounder 24; and calculating a height (h) from the bottom of the acoustic depth sounder 24 to the wetland surface using the formula

$$h = \frac{V \times t}{2} .$$

Step S4: change calculation: measuring height data at time t₁ and time t₂ using n acoustic depth sounders 24, obtaining datasets {H₁, H₂ . . . , Hₙ} and {h₁, h₂ . . . , hₙ} respectively; calculating the average difference (d) with the formula

$$d = {\sum }_{i} \frac{{H}_{i} - {h}_{i}}{n} ,$$

and determining the surface elevation change using a surface elevation change rate

$$η = \frac{d}{{t}_{2} - {t}_{1}} .$$

Specific steps for calculating the surface elevation change rate are as follows. The six acoustic depth sounders 24 on the cross-arm body 25 measure the initial heights to the wetland surface, yielding values H₁ to H₆. After a time interval Δt, the same six sounders measure the heights again, yielding values h₁ to h₆. The average of the differences between the two measurement sets, denoted as d, represents the net change in wetland surface elevation over the period. The surface elevation change rate n is then calculated as

$$η = \frac{d}{Δ t} .$$

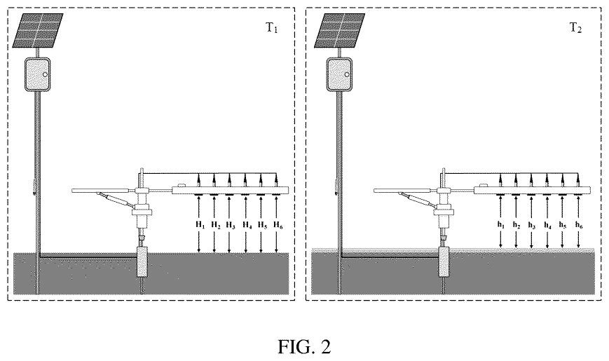

A specific example is illustrated in FIG. 2. After the water level meter verifies remotely that the water level is above the lower end of the acoustic depth sounders, a measurement command is issued at time t₁ (e.g., Mar. 1, 2024). The six heights (mm) from the acoustic depth sounders to the wetland surface are recorded as: H₁=93, H₂=95, H₃=92, H₄=90, H₅=92, H₆=96. At a later time t₂ (e.g., May 1, 2024), the measurements are repeated, yielding: h₁=95, h₂=96, h₃=95, h₄=93, h₅=95, h₆=98. The net change d and the change rate η are calculated as follows:

$$d = {\sum }_{i} \frac{{H}_{i} - {h}_{i}}{6} = 2.33 mm ;$$

$$η = \frac{d}{{t}_{2} - {t}_{1}} = 13.62 mm / yr .$$

According to the above calculation, the surface elevation change rate n in the measurement area from t₁ to t₂ is 13.62 mm/yr.

Compared with existing measurement technologies and instruments, the acoustics-based wetland surface elevation measuring instrument and measurement method of the present invention have the following advantages:

Firstly, using the acoustic depth sounder 24 for data acquisition significantly improves accuracy over manual methods. The instrument, anchored by the base 1, provides a stable reference, ensuring high data reliability and repeatability. Furthermore, integration with the communication and control module 33 enables remote data acquisition, greatly enhancing measurement efficiency.

Secondly, the measuring instrument of the present invention features structural simplicity, facilitating easy installation and operation. Compared with other instruments relying on complex mechanical and electronic assemblies that are unsuitable for intertidal zones subject to repeated seawater inundation, the present invention ensures stable and long-term operation under harsh environmental conditions such as coastal wetlands, with minimal post-deployment maintenance.

Finally, the instrument and the method in the present invention are suitable for measuring surface elevation in any water-covered wetland, indicating a wide potential for application.

1. An acoustics-based wetland surface elevation measuring instrument, comprising: a base, a measurement cross arm, and an auxiliary device base station, wherein a first end of the base is connected to the measurement cross arm, and a second end of the base is vertically anchored to a wetland geological layer; the measurement cross arm comprises a cross-arm body and an acoustic depth sounder, wherein the acoustic depth sounder is disposed on the cross-arm body; the auxiliary device base station comprises a fixed tube, and a temperature-salinity-depth meter, a communication and control module and a power supply device that are disposed on the fixed tube; the fixed tube is vertically fixed to the wetland geological layer, the temperature-salinity-depth meter comprises a probe for recording water level, temperature, and salinity, and the probe of the temperature-salinity-depth meter is maintained at a same horizontal level as a lower end of the acoustic depth sounder; the communication and control module is used for data acquisition and transmission; and the power supply device is used for supplying power to the acoustics-based wetland surface elevation measuring instrument.

2. The acoustics-based wetland surface elevation measuring instrument according to claim 1, wherein the number of the cross-arm bodies is determined according to measurement requirements, and the cross-arm bodies are arranged in a circumferential array, with equal horizontal angles between the cross-arm bodies.

3. The acoustics-based wetland surface elevation measuring instrument according to claim 1, wherein the number of the acoustic depth sounders is determined according to measurement requirements, no less than three acoustic depth sounders are disposed on each cross-arm body, and the acoustic depth sounders are fixed onto the cross-arm body at equal intervals.

4. The acoustics-based wetland surface elevation measuring instrument according to claim 3, wherein the number of the acoustic depth sounders on each cross-arm body is 3 to 9.

5. The acoustics-based wetland surface elevation measuring instrument according to claim 1, wherein the power supply device comprises a solar panel for power generation and a battery for energy storage.

6. The acoustics-based wetland surface elevation measuring instrument according to claim 1, wherein the communication and control module is connected to the temperature-salinity-water depth meter and the acoustic depth sounder respectively via corrosion-resistant wires.

7. A wetland surface elevation measurement method based on the acoustics-based wetland surface elevation measuring instrument according to claim 1, comprising the following steps:
S1: installing a base in a measurement area and calibrating a cross-arm body to be in a horizontal state to complete installation and positioning;
S2: acquiring real-time water temperature (7) and salinity(S) using the temperature-salinity-depth meter to complete environmental parameter acquisition; and calculating the in-situ speed of sound (V) in water according to the Del Grosso equation for the speed of sound in natural waters; and
S3: operating an acoustic depth sounder and the temperature-salinity-depth meter simultaneously to measure the time (t) for an acoustic wave to travel to the wetland surface and return to the bottom of the acoustic depth sounder; and calculating a height (h) from the bottom of the acoustic depth sounder to the wetland surface according to a formula
$$h = \frac{V \times t}{2} ,$$
thereby completing the elevation measurement, wherein V is the sound velocity.

8. The wetland surface elevation measurement method according to claim 7, further comprising the following steps:
S4: measuring height data at a time (t₁) and a time (t₂) using n acoustic depth sounders, obtaining datasets {H₁, H₂ . . . , Hₙ} and {h₁, h₂ . . . , hₙ} respectively; calculating the average difference (d) with the formula
$$d = {\sum }_{i} \frac{{H}_{i} - {h}_{i}}{n} ,$$
and calculating the surface elevation change using a surface elevation change rate
$$η = \frac{d}{{t}_{2} - {t}_{1}} ;$$
at a time point t1 and a time point t₂ to be H₁, H₂, . . . , Hₙ and h₁, h₂, . . . , hₙ respectively; calculating a mean value according to a formula d=(H₁−h₁+H₂−h₂+ . . . +Hₙ−hₙ)/n, and calculating a surface elevation change using a surface elevation change rate η=d/(t₂−t₁).

9. The wetland surface elevation measurement method according to claim 7, wherein the Del Grosso equation for the speed of sound in natural waters is V=1449.2+4.6T−0.055T²+0.00029T³+(1.34−0.01T)(S−35)+0.016D, wherein Tis water temperature, S is salinity, and D is depth.
